(19) United States
(12) Patent Application Publication
(10) Pub. No.: US 2007/0084412 A1
(43) Pub. Date: Apr. 19, 2007

(54) Hanging feeder for allowing accessing of suet therein by birds and not squirrels

(76) Inventor: Robert H. Eager, Marlborough, MA (US)

Correspondence Address: RICHARD L. MILLER, 12 PARKSIDE DRIVE, DIX HILLS, NY, 11746, US

(21) Appl. No.: 11/254,191

(22) Filed: Oct. 19, 2005

(51) Int. Cl. A01K 39/01

(52) U.S. Cl. 119/51.03

(57) ABSTRACT

A hanging feeder for allowing accessing of suet therein by birds and not by squirrels. The feeder includes an outer cage and an inner cage. The inner cage is contained in the outer cage, and contains and maintains the suet at such a distance from the outer cage to allow access thereto by the birds and not by the squirrels by virtue of the inner cage having all of its sides spaced a sufficient distance from adjacent sides of the outer cage. The outer cage has a lid, a latch pin with a through bore, and a safety pin. The latch pin extends upwardly from a side of the outer cage, which is opposite to that on which the lid is hinged, and through the lid when the lid is closed to have the through bore in the latch pin receive the safety pin to selectively maintain the lid closed.

### BACKGROUND OF THE INVENTION

1Field of the Invention:

The present invention relates to a hanging feeder for allowing accessing of suet therein by birds, and more particularly, the present invention relates to a hanging feeder for allowing accessing of suet therein by birds and not by squirrels.

2Description of the Prior Art:

Numerous innovations for bird feeders have been provided in the prior art that will be described. Even though these innovations may be suitable for the specific individual purposes to which they address, however, they differ from the present invention.

A FIRST EXAMPLE, U.S. Pat. No. 4,434,745 issued on Mar.6, 1984 to Perkins et al. teaches a bird feeding device that can be accessed by birds and not by squirrels. The device includes a container for holding feed and a wire mesh enclosing the container. An O-ring supports the container within the wire mesh and spaces the mesh away from the container so that the mesh is not directly in contact with the container whereby squirrels are prevented from accessing the container.

A SECOND EXAMPLE, U.S. Pat. No. 5,016,573 issued on May 21, 1991 to Power teaches a hanging type or ground supported bird observation enclosure, selectively limiting, squirrel resistant, provisioned with apparatus for installation of at least one feed or drink receptacle within interior confines. Including the enclosure is an open mesh body structure, ported by an plurality of circular openings, sealed by a closure on one end, the other having at least one cover, for feed or drink replenishment.

A THIRD EXAMPLE, U.S. Pat. No. 5,111,772 issued on May 12, 1992 to Lipton teaches a housing for a food dispenser for birds, which has a band of contiguous apertures that are elongated transversely of the band. Each aperture has a width of 2 to 4 cm over at least a 5 cm length thereof. The apertures enable small birds to enter the enclosed space inside the housing in order to eat from the food dispenser. The apertures are, however, too small to permit squirrels to gain entry. Because the apertures are in a band, the birds are less likely to feel trapped inside the housing.

A FOURTH EXAMPLE, U.S. Pat. No. 5,806,458 issued on Sep. 15, 1998 to Harwich teaches a flying animal or bird feeder. The feeder includes first and second faces, each face having a raised periphery. The raised periphery preferably includes sleeves that wrap around peripheral rods. A hinge member permits the feeder to be placed in both an open and a closed orientation. In its open orientation, a source of food, such as suet, may be put on one of the faces. The feeder may then be placed in its closed orientation so that the source of food is compressed between the faces in a sandwich-like fashion. Access to the food can be gained by flying birds, insects, and the like through apertures in one or both of the faces. In one embodiment, the raised periphery of the first face engages the raised periphery of the second face when the feeder is in its closed orientation. These raised peripheries prevent consumption of the source of food by non-flying animals, such as squirrels, raccoons, and the like.

A FIFTH EXAMPLE, U.S. Pat. No. 6,024,047 issued on Feb. 15, 2000 to Hoogland teaches a bird feeder for retaining compressed suet-seed cakes, which has a construction permitting easier refill of the feeder, as well as making it more difficult for squirrels and other animals from raiding the feeder. Two embodiments of the feeder are disclosed including a hinged side door that is kept closed under tension equal to the weight of the suspended feeder and one having foldable perches that conserves packing material and space.

A SIXTH EXAMPLE, U.S. Pat. No. 6,647,921 B2 issued on Nov. 18, 2003 to Stokes et al. teaches a birdfeeder having a base and a cage or openwork attached to the base. The openwork has a plurality of substantially longitudinal members attached to the base and arranged radially about a central axis. A feed container releasably coupled to the base is positioned interior the openwork and spaced-apart therefrom. At least two of the longitudinal members are spaced-apart one from the other so that certain birds can enter the openwork and access the feed container. The openwork can include a plurality of substantially horizontal members wherein at least two of the horizontal members are spaced-apart one from the other to allow certain birds to enter the openwork. The feed container being releasably coupled to the base allows the feed container to be easily removed from the openwork. The feed container can extend through an opening in the openwork for accessing the feed container exterior the openwork.

A SEVENTH EXAMPLE, U.S. Pat. No. D498,335 issued on Nov. 9, 2004 to Donegan shows the ornamental design for an exclusion cage for use with bird feeders.

It is apparent that numerous innovations for bird feeders have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

Accordingly, it is an object of the present invention to provide a hanging feeder for allowing accessing of suet therein by birds and not by squirrels that avoids the disadvantages of the prior art.

Briefly stated, another object of the present invention is to provide a hanging feeder for allowing accessing of suet therein by birds and not by squirrels. The feeder includes an outer cage and an inner cage. The inner cage is contained in the outer cage, and contains and maintains the suet at such a distance from the outer cage to allow access thereto by the birds and not by the squirrels by virtue of the inner cage having all of its sides spaced a sufficient distance from adjacent sides of the outer cage. The outer cage has a lid, a latch pin with a through bore, and a safety pin. The latch pin extends upwardly from a side of the outer cage, which is opposite to that on which the lid is hinged, and through the lid when the lid is closed to have the through bore in the latch pin receive the safety pin to selectively maintain the lid closed.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic perspective view of the hanging feeder of the present invention in the closed position and allowing accessing of suet therein by birds and not by squirrels;

FIG. 2 is a diagrammatic perspective view of the hanging feeder of the present invention in the open position and allowing accessing of suet therein by birds and not by squirrels;

FIG. 3 is an enlarged diagrammatic perspective view of the area generally enclosed by the dotted curve identified by ARROW 3 in FIG. 2;

FIG. 4 is an enlarged diagrammatic perspective view of the area generally enclosed by the dotted curve identified by ARROW 4 in FIG. 2 of the hanging feeder of the present invention; and

FIG. 5 is an exploded diagrammatic perspective view of the area generally enclosed by the dotted curve identified by ARROW 5 in FIG. 2 of the hanging feeder of the present invention.

### LIST OF REFERENCE NUMERALS UTILIZED IN THE DRAWING

10 hanging feeder of present invention for allowing accessing of suet 11 therein by birds 12 and not by squirrels 13
11 suet
12 birds
14 squirrels
16 outer cage
18 inner cage for containing suet 11 and maintaining suet 11 at such distance from outer cage 16 to allow access thereto by birds 12 and not by squirrels 14
20 lid of outer cage 16
22 lid of inner cage 18
24 bottom of outer cage 16
26 bottom of inner cage 18
28 spacers of outer cage 16
30 spacers of lid 20 of outer cage 16
32 latch pin of outer cage 16
34 through bore in latch pin 32 of outer cage 16
36 safety pin

### DETAILED DESCRIPTION OF THE PREFERRED EMBODIMENT

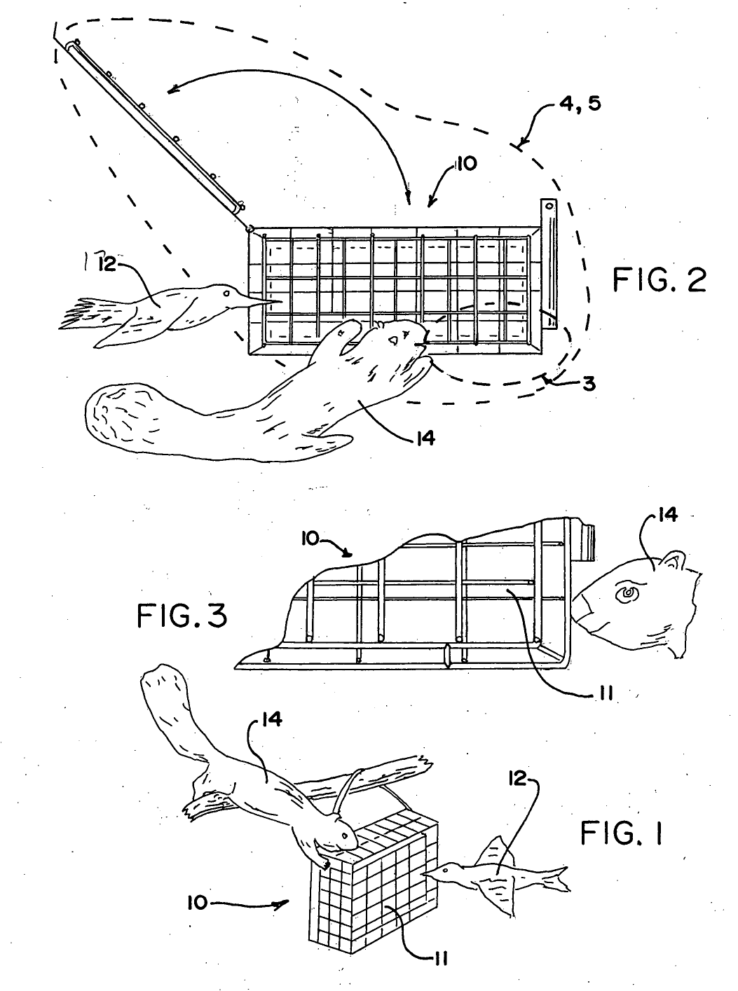

Referring now to the figures, in which like numerals indicate like parts, and particularly to FIGS. 1-3, which are, respectively, a diagrammatic perspective view of the hanging feeder of the present invention in the closed position and allowing accessing of suet therein by birds and not by squirrels, a diagrammatic perspective view of the hanging feeder of the present invention in the open position and allowing accessing of suet therein by birds and not by squirrels, and an enlarged diagrammatic perspective view of the area generally enclosed by the dotted curve identified by ARROW 3 in FIG. 2, the hanging feeder of the present invention is shown generally at 10 for allowing accessing of suet 11 therein by birds 12 and not by squirrels 13.

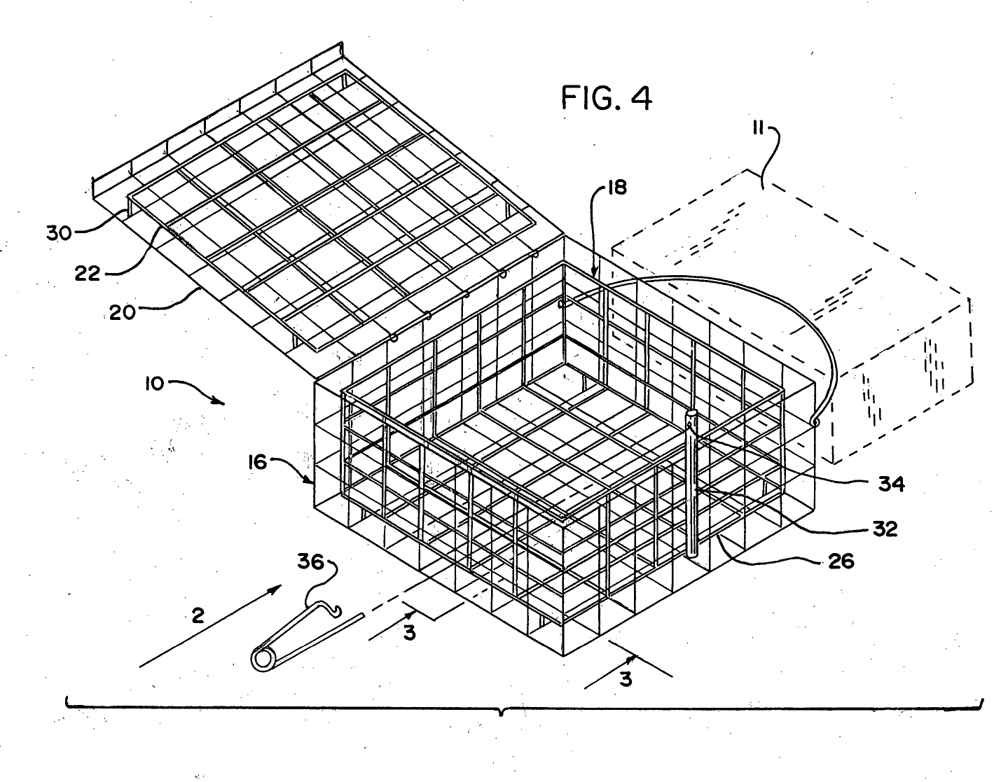

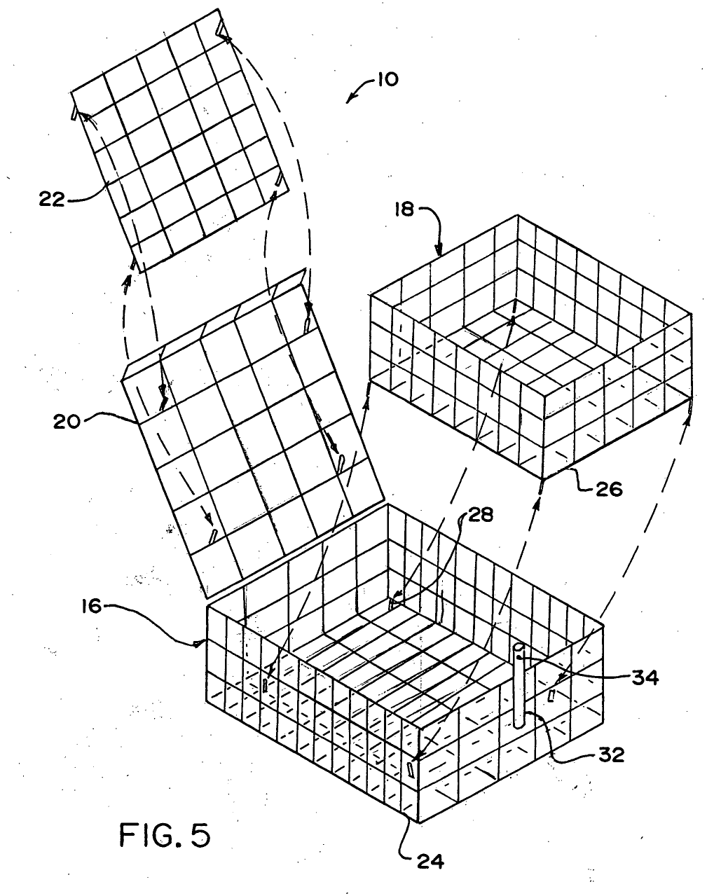

The configuration of the hanging feeder device 10 can best be seen in FIGS. 4 and 5, which are, respectively, an enlarged diagrammatic perspective view of the area generally enclosed by the dotted curve identified by ARROW 4 in FIG. 2 of the hanging feeder of the present invention, and an exploded diagrammatic perspective view of the area generally enclosed by the dotted curve identified by ARROW 5 in FIG. 2 of the hanging feeder of the present invention, and as such, will be discussed with reference thereto.

The hanging feeder 10 comprises an outer cage 16 and an inner cage 18. The inner cage 18 is contained in the outer cage 16 and is for containing the suet 11 and maintaining the suet 11 at such a distance from the outer cage 16 to allow access thereto by the birds 12 and not by the squirrels 14.

The outer cage 16 is preferably generally box-like and made of a mesh defining apertures of a size to allow the birds 12 to access the suet 11 in the inner cage 18 and not the squirrels 14.

The outer cage 16 has a lid 20 that is hingedly attached thereto to allow access to the inner cage 18 and the suet 11 therein

The inner cage 18 is generally box-like, made of mesh, and has all of its sides spaced a distance from adjacent sides of the outer cage 16 to allow access of the suet 11 therein by the birds 12 and not by the squirrels 14. The inner cage 18 has a lid 22 that is spacingly attached to the lid 20 of the outer cage 16 to allow access to the inner cage 18 and the suet 11 therein.

The outer cage 16 has a bottom 24 and the inner cage 18 has a bottom 26. The bottom 24 of the outer cage 16 has spacers 28 extending upwardly therefrom. The spacers 28 of the outer cage 16 engage the bottom 26 of the inner cage 18 to space the inner cage 18 a distance from the outer cage 16 to allow access to the suet 11 in the inner cage 18 by the birds 12 and not by the squirrels 14.

The lid 20 of the outer cage 16 has spacers 30 depending therefrom. The spacers 30 of the lid 20 of the outer cage 16 engage the lid 22 of the inner cage 18 to space the lid 22 of the inner cage 18 a distance from the lid 20 of the outer cage 16 to allow access to the suet 11 in the inner cage 18 by the birds 12 and not by the squirrels 14.

The outer cage 16 further has a latch pin 32 with a through bore 34. The latch pin 32 of the outer cage 16 extends upwardly from a side thereof, which is opposite to that on which the lid 20 of the outer cage 16 is hinged, and through the lid 20 of the outer cage 16 when the lid 20 of the outer cage 16 is closed to have the through bore 34 therein receive a safety pin 36 that selectively maintains the lid 20 of the outer cage 16 closed.

It will be understood that each of the elements described above, or two or more together, may also find a useful application in other types of constructions differing from the types described above.

While the invention has been illustrated and described as embodied in a hanging suet feeding device for accessing by birds and not by squirrels, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A hanging feeder for allowing accessing of suet therein by birds and not by squirrels, comprising:
a) an outer cage; and
b) an inner cage;
wherein said inner cage is contained in said outer cage;
wherein said inner cage is for containing the suet;
wherein said inner cage is for maintaining the suet at such a distance from said outer
cage to allow access thereto by the birds and not by the squirrels;
wherein said outer case has a lid;
wherein said inner cage has a lid; and
wherein said lid of said inner cage is spacingly attached directly to said lid of said outer cage so as to form a combination allowing said lid of said inner cage and said lid of said outer cage to move as a unit and allow access to said inner cage and the suet therein by moving said combination.

2. The feeder of claim 1, wherein said outer cage is generally box-like.

3. The feeder of claim 1, wherein said outer cage is made of a mesh;
wherein said mesh of said outer cage defines apertures; and
wherein said apertures of said mesh of said outer cage are of a size to allow the birds to access the suet in said inner cage and not the squirrels.

4. (canceled)

5. The feeder of claim 1, wherein said lid of said outer cage is hingedly attached thereto to allow access to said inner cage and the suet therein.

6. The feeder of claim 1, wherein said inner cage is generally box-like.

7. The feeder of claim 1, wherein said inner cage is made of mesh.

8. The feeder of claim 1, wherein said inner cage has all of its sides spaced a distance from adjacent sides of said outer cage to allow access of the suet therein by the birds and not by the squirrels.

9. (canceled)

10. (canceled)

11. The feeder of claim 1, wherein said outer cage has a bottom;
wherein said bottom of said outer cage has spacers; and
wherein said spacers of said bottom of said outer cage extends upwardly therefrom.

12. The feeder of claim 11, wherein said inner cage has a bottom; and
wherein said spacers of said outer cage engage said bottom of said inner cage to space said inner cage a distance from said outer cage to allow access to the suet in said inner cage by the birds and not by the squirrels.

13. The feeder of claim 1, wherein said lid of said outer cage has
spacers; and
wherein said spacers of said lid of said outer cage depend therefrom.

14. The feeder of claim 13, wherein said spacers of said lid of said outer cage engage said lid of said inner cage to space said lid of said inner cage a distance from said lid of said outer cage to allow access to the suet in said inner cage by the birds and not by the squirrels.

15. The feeder of claim 5, wherein said outer cage has a latch pin.

16. The feeder of claim 15, wherein said latch pin of said outer cage has a through bore.

17. The feeder of claim 16, wherein said latch pin of said outer cage extends upwardly from a side thereof; and
wherein said side of said outer cage is opposite to that on which said lid of said outer cage is hinged.

18. The feeder of claim 17, wherein said outer cage has a safety pin;
wherein said latch pin of said outer cage extends through said lid of said outer cage when said lid of said outer cage is closed to have said through bore therein receive said safety pin of said outer cage; and
wherein said safety pin of said outer cage selectively maintains said lid of said outer cage closed.
